(19) United States
(12) Patent Application Publication
(10) Pub. No.: US 2008/0126207 A1
(43) Pub. Date: May 29, 2008

(54) Method for increasing use of alternative transportation network

(76) Inventor: Andrew S. Brown, Sanibel, FL (US)

Correspondence Address: BIRCH STEWART KOLASCH & BIRCH, PO BOX 747, FALLS CHURCH, VA, 22040-0747, US

(21) Appl. No.: 11/979,338

(22) Filed: Nov. 1, 2007

Related U.S. Application Data
(60) Provisional application No. 60/856,794, filed on Nov. 6, 2006.

(51) Int. Cl. G06Q 30/00

(52) U.S. Cl. 705/14

(57) ABSTRACT

A method involves associating a plurality of readable tags having user identifiers with a plurality of users, storing the user identifier of each of the readable tags in a database, and reading the tags using a plurality of tag readers disposed across a transportation network as the users carrying the tags traverse portions of the network. The identifier of the tag reader reading a tag is stored in association with a user identifier of the tag that was read, and transportation network usage is determined by the plurality of users based on the tag reader identifiers stored in the database. When transportation network usage for a given readable tag exceeds a transportation network usage minimum threshold, a reward is given to the user associated with the given readable tag.

### CROSS-REFERENCE TO RELATED APPLICATION

The present application claims the benefit of U.S. Provisional Patent Application No. 60/856,794, filed Nov. 6, 2006, the entire contents of which is hereby incorporated by reference.

### FIELD OF THE INVENTION

The present invention is directed toward a method of increasing the use of an alternative transportation network, and, more specifically, toward a method of increasing the use of an alternative transportation network by providing rewards to users of the alternative transportation network

### BACKGROUND OF THE INVENTION

Across the country, government officials and communities face several difficult issues regarding growth management. Infrastructures in various communities face a seemingly endless battle where demand consistently exceeds capacity. This difficult factor is most prevalent and challenging regarding roads and vehicular traffic. Demand exceeds capacity while pollution and other costly congestion-related problems persist. Solutions not requiring significant additional infrastructure or stress to existing systems are rare.

Following several federal legislative Acts such as the Federal Intermodal Surface Transportation Efficiency Act of 1991 (ITSEA) and the Clean Air Act of 1990, programs and studies regarding alternatives to automobile transportation have increased significantly. According to the Alternative Transportation web site www.transalt.org, ITSEA gave “cities and states an opportunity to develop innovative, environmentally-sustainable transportation strategies.” The same website cites the significant costs associated with “motor vehicle proliferation.” Transalt.org estimated that in New York City alone, the costs associated with motor vehicle proliferation are 21 billion dollars per year.

While most of the alternative transportation issues covered in the mainstream media focus on alternative fuel concerns, there is a significant movement to increase usage of bicycles as an alternative to automobile use. While bicycles are the focus of such studies, increasing the use of human power for transportation, including more use of walking or human powered devices such as inline roller skates and battery powered devices such as Segway brand transporters is also desirable. The term “bicycle” will generally be used herein; however, it should be understood that increasing the use of walking or other non-motor vehicle transportation modes is included in the scope of this discussion.

A study conducted on the New York City alternative transportation program and sited on the Transalt website indicated that planning for automobiles and highways tends to crowd out even marginal improvements for cyclists. This does little to decrease congestion and prevents more people from obtaining the health benefits provided by cycling. The TransAlt website also notes that many cities have increased organization regarding alternative transportation, including many with alternative transportation programs within their Departments of Transportation. Chicago is one large city that has a significant alternative transportation department. According to www.Transalt.org, Chicago is one of the best places to bike in the country.

Most of the promotion and encouragement efforts to date seem to target bicycling infrastructure rather than incentives as a means to promote bicycle use. For example, according to the Chicago's alternative transportation web page, promotion efforts focus on providing public bicycle parking, pathways and programs designed to facilitate usage such as allowing bicycles on public transportation carriers (trains, buses, etc.). In a movement toward more meaningful usage encouragement, communities are also experimenting with usage incentives. The university of California at Berkley and the California Department of Transportation, for example, have studied the effectiveness of providing Segways to commuters who utilize public transportation to arrive near their places of employment.

One known method of reducing congestion caused by motor vehicles is known as “congestion pricing.” This method charges drivers different amounts for road usage based on the time of day. Such pricing can help reduce peak period congestion by encouraging drivers, when possible, to avoid the roadways at the busiest times of day. However, congestion pricing generally only shifts the times of day that automobiles are on the road and does little to encourage the use of alternative transportation modes. It would therefore be desirable to provide a method of encouraging alternative transportation use, such as bicycle use, particularly during peak traffic periods.

### SUMMARY OF THE INVENTION

These problems and others are addressed by embodiments of the present invention, a first aspect of which comprises a method that involves associating a plurality of readable tags with a plurality of users, each of the readable tags storing a user identifier, and storing the user identifier of each of the readable tags in a computer database. The method also involves providing a plurality of tag readers across a transportation network each identified by its own identifier and having a tag reading field. The tag readers are adapted to read the user identifier on readable tags located within the tag reading field associated with that tag reader. The method also includes reading the user identifiers of the readable tags in the tag reading fields of the tag readers and storing in the database the tag reader identifier of the tag reader reading a given readable tag in association with the user identifier associated with said given readable tag. Transportation network usage by the plurality of users is determined based on the tag reader identifiers stored in the database in association with each user identifier of each of the users, and, when transportation network usage for a given readable tag exceeds a transportation network usage minimum threshold, a reward is provided to the user associated with the given readable tag that has exceeded the minimum usage threshold.

Another aspect of the invention comprises a method involving associating a plurality of readable tags with a plurality of users, each of the readable tags storing a user identifier, and storing the user identifier of each of the readable tags in a computer database. The method further involves providing a plurality of tag readers across a transportation network, each tag reader identified by a tag reader identifier and having a tag reading field. The tag readers can read the user identifier on readable tags located within the tag reading field associated with that tag reader. A reader reads the user identifier from a first one of the plurality of readable tags in the tag reading field of a first tag reader at a reading time and stores the reading time and tag reader identifier of the tag reader reading the user identifier in the database in association with the user identifier. Then a determination of transportation network usage by each of the users is made based on the tag reader identifiers and reading times stored in the database in association with each user identifier, and when transportation network usage for a given readable tag exceeds a transportation network usage minimum threshold, a reward is provided to the user associated with the given readable tag.

A further aspect of the present invention comprises a method that involves associating a plurality of readable tags with a plurality of users, each of the readable tags storing a user identifier, and storing the user identifier of each of the readable tags in a computer database. The method also involves providing a plurality of tag readers across a transportation network, where each of the plurality of tag readers is identified by a tag reader identifier and a tag reader network location. Each of the plurality of tag readers has a tag reading field and is adapted to read the user identifier on readable tags located within the tag reading field associated with the tag reader and to record a reading time at which a given tag is read. The method includes providing a transportation network usage field in association with each of the user identifiers in the database, reading the user identifier from a first one of the plurality of readable tags in the tag reading field of a first tag reader at a first reading time, and storing the tag reader identifier of the tag reader reading the user identifier and the first reading time in the database in association with the user identifier. In addition, the user identifier of the first one of the plurality of readable tags is read in the tag reading field of a second tag reader at a second reading time, and the tag reader identifier of the tag reader reading the user identifier and the second reading time are stored in the database in association with the user identifier. The transportation network usage field is incremented based on the first reading time or the second reading time and based on an elapsed time between said first reading time and said second reading time and based on the tag reader network location of the tag reader reading the user identifier at the first reading time and the network location of the tag reader reading the user identifier at the second reading time. When transportation network usage for a given readable tag exceeds a transportation network usage minimum threshold, a reward is provide to the user associated with the given readable tag.

### BRIEF DESCRIPTION OF THE DRAWINGS

These aspects and features of the invention and others will be better understood after a reading of the following detailed description together with the attached drawings wherein:

FIG. 1 is a map of a geographic region in which a network of tag readers is disposed;

FIG. 2 is an elevational view of a bicycle having a readable tag mounted thereon;

FIG. 3 is an elevational view of an in-line roller skate having a readable tag mounted thereon;

FIG. 4 is a perspective view of one of the tag readers of FIG. 1 showing first and second reading fields;

FIG. 5 is a plan view of a portion of the map of FIG. 1 showing a bike path running alongside a road;

FIG. 6 is a plan view of a business having a bike rack having a tag reader mounted thereon;

FIG. 7 is a view of a screen showing a database record containing information regarding a first user during a first date range;

FIG. 8 is a view of a screen showing a database record containing information regarding a first user during a second date range;

FIG. 9 is a view of a screen showing a database record containing information regarding a first user during a third date range;

FIG. 10 is a view of a screen showing a database record containing information regarding a first user during a fourth date range;

FIG. 11 is a view of a screen showing a database record containing information regarding a first user during a fifth date range;

FIG. 12 is a view of a screen showing a database record containing information regarding a first user during a sixth date range; and

FIG. 13 is a flow chart illustrating a method according to an embodiment of the present invention.

### DETAILED DESCRIPTION

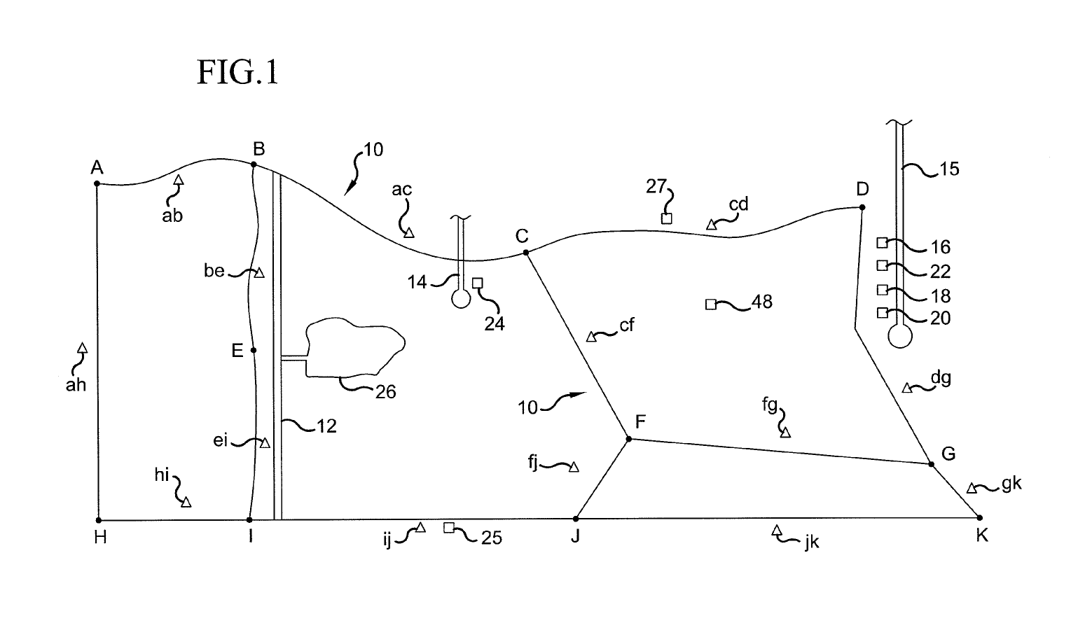

Referring now to the drawings, wherein the showings are for purposes of illustrating embodiments of the invention only and not for the purpose of limiting same, FIG. 1 is a map of a geographic area in which embodiments of the present invention are practiced. FIG. 1 illustrates a plurality of bike paths which are divided into path segments which meet at nodes. The bike path is referred to herein generally as path 10, and the nodes include first through eleventh nodes labeled node A through node K, respectively. To refer to particular segments of path 10, the nodes at the end points of those segments will be identified. Thus, the portion of bike path 10 at the upper left-hand portion of FIG. 1, running from first node A to second node B, may be referred to as segment AB. A first road 12, a second road 14 and a third road 15 are also illustrated. As used herein, “road” indicates a travel path available for use by automobiles. Bike paths 10 may comprises dedicated bicycle paths or shared-use trails on which automobiles are not permitted as well as bike lanes or other portions of a road on which bicycles are permitted.

The first road 12 runs alongside and is physically close to segment BI of the bike path 10, the second road 14 crosses bike path 10 between second node B and third node C, and the third road 15 is separated from the nearest bike path segment DG by a row of businesses which businesses include first, second and third participating businesses 16, 18, 20 (as defined hereinafter) and a non-participating business 22. The homes 24, 25, 27 of first, second and third system users, respectively, and a city park 26 off first road 12 are also illustrated. This hypothetical geographical area is provided for purposes of illustration only. Actual cities or towns will have different numbers and layouts of bicycle or shared-use paths and different configurations of roads in relation to the bicycle paths.

The present invention is directed to reducing motor vehicle traffic on roads, such as roads 12, 14, and 15, by encouraging use of alternative methods of transportation appropriate to shared-use or bicycle path 10. One of the primary anticipated alternative modes of transportation contemplated for use with the system and method described herein is the bicycle, and embodiments of the present invention may be described herein in terms of bicycle use. However, bicycles are not the only alternative transportation mode. Inline roller skates, Segway brand transporters, or even, in some environments, horses or cross-country skis, could constitute the alternative transportation mode. Any permissible method of transportation that is permitted on existing shared-use pathways will fall within the category of alternative transportation, as long as the transportation mode removes motor vehicles from roads. Even walking could be considered an alternative to transportation, and the embodiments of the present invention could, optionally, apply to pedestrians. However, as discussed further herein, it may not always be desirable to include pedestrians as users of a system such as the system described herein.

There are four main functional components of the proposed system and program: 1) the basic technology required to accurately track shared-use path usage 2) city-sanctioned meaningful and sustainable incentives for users to increase path usage, particularly during peak seasonal and daily traffic periods; 3) city-sanctioned incentives for businesses to participate and subsequently reward participating users who utilize shared-use paths to arrive at and patronize their businesses; and 4) businesses having the ability to identify and verify enrolled system participants who arrive at the various participating businesses via an enrolled bicycle. Following is a general description of each of the system components mentioned above.

Embodiments of the present invention make use of existing radio frequency identification (RFID) technology to track shared-use path usage by system participants. Suitable RFID tags and readers are available, for example, from the TransCore division of Roper Industries, Inc. located in Hummelstown, Pa. This is the same technology used in electronic toll-collection and motor vehicle tracking where transponders, which may be referred to herein as “tags,” are read by readers when the motor vehicle is near a reading antenna of the reader. The tags and tag readers can be made minimally visible and therefore not functionally or aesthetically intrusive. While the use of RFID tags is presently considered to be the best mode of practicing the present invention, any other non-contact method for the short-range reading of information from a person passing a reading point that indicates to a monitoring system that a program participant is at that reading point would also be effective.

The locations of tag readers at various read-points as well as the specific number of read-points can vary depending on the desired capabilities of the system. At a minimum, it would be desirable to provide at least one reader between each pair of nodes in the system to allow the system to determine whether a segment between two nodes has been traversed. If a destination that is likely to be visited by alternative transportation riders, such as park 26 in FIG. 1, is known, it may also be desirable to define a node, such as fifth node E, near that destination so that system usage by a participant traveling to that destination can be more accurately tracked. Greater accuracy regarding system use can be obtained with a greater number of readers. Too large a number of readers, however, may have privacy implications as they would allow the location of users to be known with a high degree of accuracy at any time. Placing readers between nodes, however, makes it more difficult to determine the exact location of a user but still provides enough information to reward increased system use.

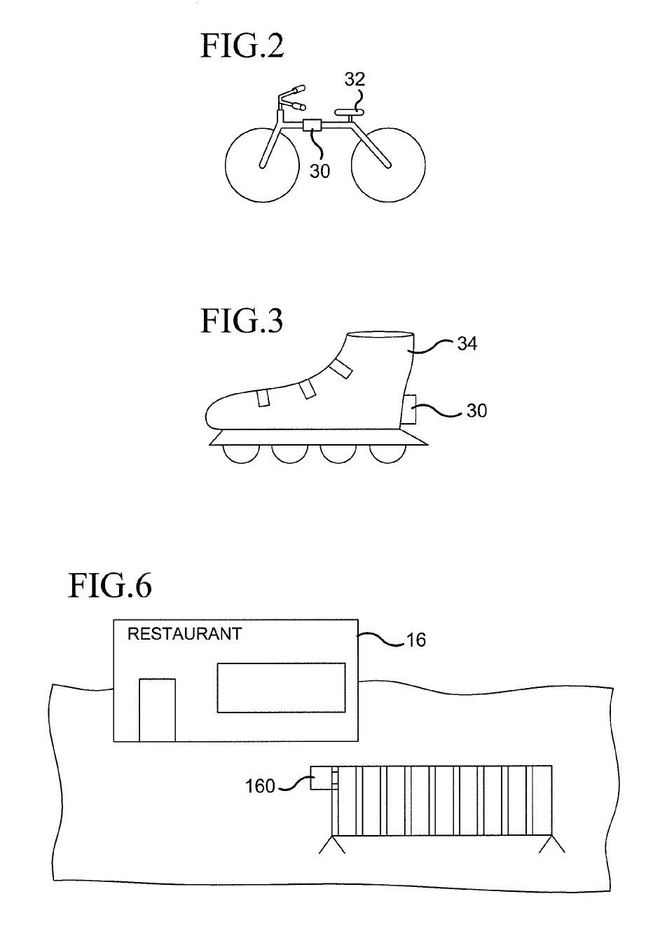

Using the method and system of an embodiment of the present invention, a city or other governmental entity would make transponders/tags 30 available to persons who choose to enroll and participate in the program, and the participants would attach tags 30 to an alternative transportation vehicle. A tag 30 attached to a bicycle 32 is illustrated in FIG. 2; a tag 30 attached to an inline roller skate 34 is illustrated in FIG. 3. Fees could optionally be charged for participating in the program which fees could be waived for persons making at least a minimal amount of use of the system during, for example, the first month of participation. On certain islands or in resort locations, where non-residents are responsible for a large portion of road congestion, rental bicycles, could also be equipped with tags 30. The various tags or transponders are programmed with a unique identifier associated with a given participant; in the case of the rental bicycles, user identification information could changed each time a new person rents the bicycle.

An example of a suitable distribution of tag readers, referred to generally as readers 38, is illustrated in FIG. 1, with small triangles representing the location of each tag reader 38. The location of these readers 38 in turn is referred to herein by the lower case letters of path segment where the reader is located. Therefore, for example, the reader 38 in the upper left corner of the map of FIG. 1, on path segment AB, is located at reading location ab and may sometimes be referred to herein as tag reader ab. Additional readers 38 can be located at businesses, such as the reader 160 located at business 16 illustrated in FIG. 6, to record the presence of a registered user at that business in order to reward the user of the present system for arriving at business 16 by bicycle.

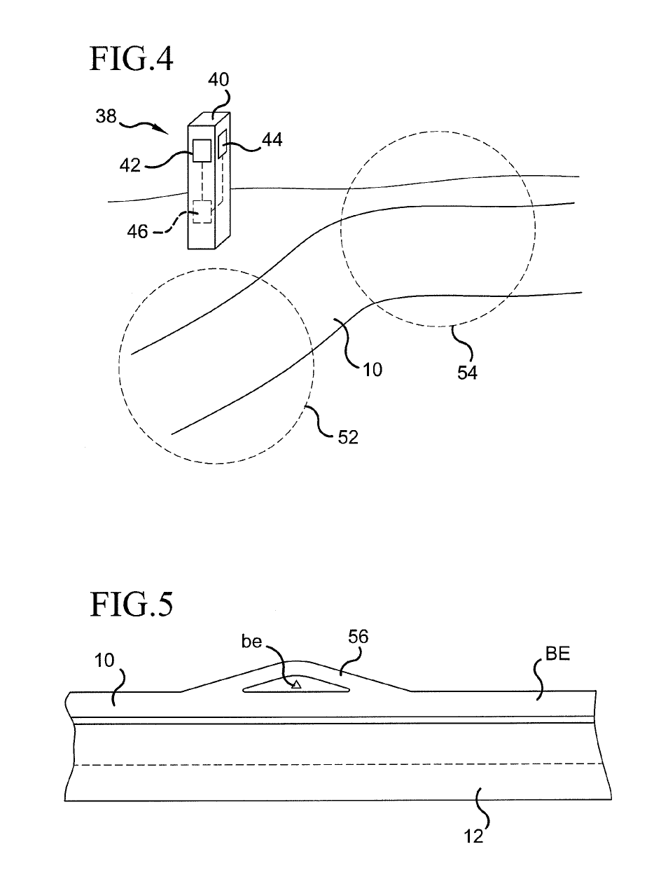

The structure of one of the tag readers 38, is illustrated in FIG. 4. The tag reader comprises a post 40 a first reading antenna 42 and a second reading antenna 44 connected to an internal processor 46 for communicating with a computer hosting a central database 48 in any suitable manner, such as wirelessly or over a telephone or hardwired network (not shown). The tag readers may either communicate with the central database 48 continuously or in near real time or, alternately, may store information regarding passing tags and send the information once per hour or other period to reduce transmission costs. Such an arrangement may, for example, allow for the use of an existing cellular network to send results from each reader several time each day instead of contacting the database each time a tag is read by one of the readers. When readings are stored and transmitted in batches, the readers will be configured to record a read time for each tag read and to send this information to the computer database 48. When tag readings are sent substantially instantaneously, the reading times can, optionally, be generated by the computer hosting the central database.

Tag reader 38 includes a first read zone 52 and a second read zone 54 extending a known distance from the first and second antennas 42, 44, respectively. Using a pair of antennas allows the direction that a user is travelling to be determined, for example, by determining which of the two readers reads the tag first. This may allow for more precise tracking of system usage; however, a single antenna could also be used. While not illustrated in FIG. 4, post 40 could be partially hidden by shrubbery to minimize its visible impact.

When bike path segments are located adjacent to or along the edge of a road, such as path segment BE along road 12, it may be possible for unscrupulous users of the system to carry a tag 30 in a vehicle and have the tag read by reader be as the vehicle traverses the adjoining road. If path segment BE is spaced from first road 12 by a small median, for example, it may be desirable to mount the tag reader 38 on the median facing away from first road 12 so that the reader will not read tags on passing vehicles. Where a path segment follows along the side or shoulder of a road, a detour 56, illustrated in FIG. 5, may be provided which is only traversable by bicycles. Here riders who participate in the system of the present invention would be instructed to use these short detours to ensure that their passage by the reader is noted.

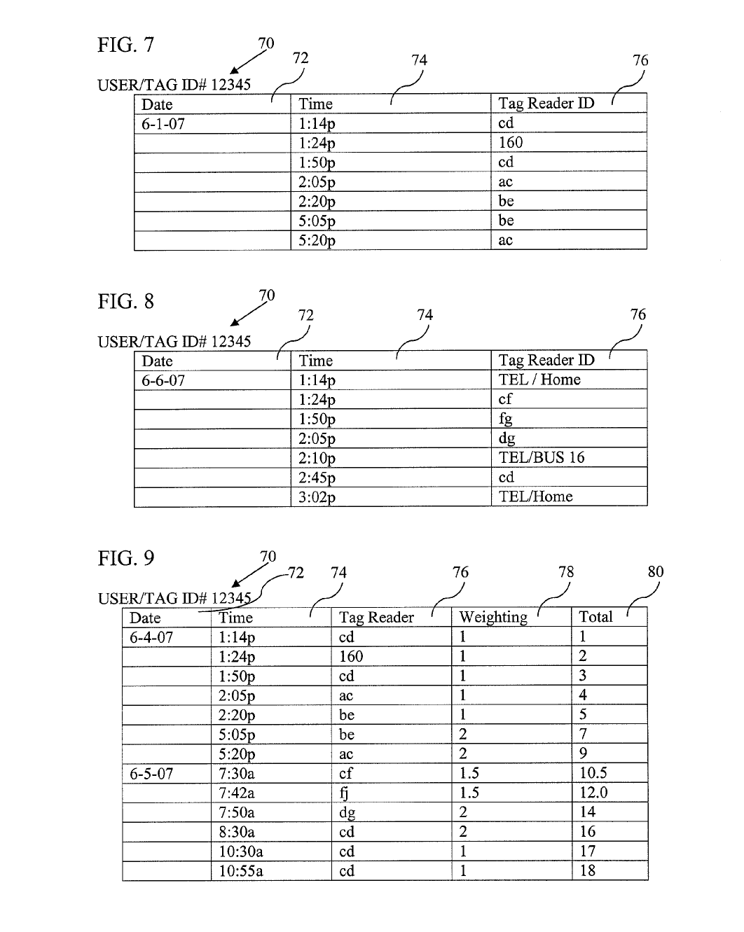

Computer database 48 maintains records associated with each registered system user and records the time a tag associated with that user passes a tag reader. As illustrated in FIG. 7, a record for a given user may include the user's identification number 70, a date column 72, a time column 74 and a tag reader identification column 76 listing an identifier of a reader that reads the user's tag 30 at a given time. Additional database fields can be provided, such as elapsed time between reads, or this information can be calculated periodically from the information in the database.

FIG. 7 illustrates system use by a user with user ID 12345 on Jun. 1, 2007, who lives at location 24 on road 14. Only a portion of this user's use record is shown, and several weeks or months worth of data can be maintained in database 48 for a given user. With reference to FIG. 7 and the map of FIG. 1, it can be seen that this first user passes tag reader location cd at 1:14 pm and that the tag 30 on the first user's bicycle is read by tag reader 160 at participating business 16 at 1:24 pm. About 25 minutes later, the first user's tag is read again by tag reader cd. Thus, at a minimum, the present system can determine from the information illustrated in FIG. 7 that the first user passed three read points during a given time period and the user can be credited with, for example, three units of system use. If the location of the user's home 24 is available to the system, it can reasonably be assumed that the user traveled from his home 24 to business 16 and then returned home. Because the distance between the user's home 24 and reader cd is relatively long, that user might be credited with additional system usage, more so than, for example, a third user living at location 27 who had the same tag reader/readpoints recorded in his data record. It can further be seen that later that same day, the first user traveled past read point ac and point be shortly after 2:00 pm and then traveled past these same read points in the reverse order shortly after 5:00 pm. These readings are consistent with the first user traveling from his home at location 24 to the park 26 and then returning home. Four additional units of use might be credited to the first user based on this trip.

As discussed above in connection with FIG. 7, a basic embodiment of the present invention may not adequately distinguish between path use by persons living close to a tag reading location and persons living far from a tag reading location. The first embodiment also requires that participating businesses install tag readers or otherwise have readers (such as, for example, bar code readers) available to read other indicia on a user's tag when the user arrives at a participating business. The second embodiment of the present invention, therefore, permits a user to telephone the computer hosting database 48 from his home or the registered location of a participating business and enter his ID number before starting a bicycle trip. Thus, as illustrated in FIG. 8, first user telephones the database 48 at 1:14 and the first user's tag is then read by the tag reader at location cf ten minutes later. The user subsequently passes reading locations fg and dg and arrives at participating business 20. Business 20 does not have a tag reader; however, business 20 provides a telephone for use by customers who arrive by bicycle, and the first user telephones database 48 upon arrival, enters his identification number, and is given credit for an amount of system usage including travel from home 24 to first read location cf and from read location dg to business 20. To reduce the occurrence of fraud, the system may be configured so that a person identifying a start and end location by telephone must also have their tag read by a tag reader between the start and finish locations so that persons driving to a participating business do not merely call database 48 upon arrival to obtain unearned credit for shared-path usage.

As a further alternative, businesses may be able to verify enrollment as well as recent path travel of participants by accessing an information management system. Essentially, participating businesses would identify the read-points closest to their businesses. When an individual participant arrives at the business and identifies himself as a participant who wishes to take advantage of the discount offered by the particular business, the business staff would access the information management system (software) to verify 1) the identification of the member and 2) that the member had in fact recently (within a predetermined amount of time, 30 minutes for example) passed one of the read-points nearest the business. This arrangement avoids the need to install tag readers or provide telephones for use by system users The businesses might need install barcode readers to read barcodes on the user's bicycle or on an identification card carried by a user to verify enrollment in the system.

FIG. 9 illustrates a database record for user 12345 that includes information in addition to the information of FIG. 7. In FIG. 9, a weighting factor, column 78, is assigned to each tag read based on the date and time of the tag read, and a running total of weighted values is maintained in column 80. Thus, in FIG. 9, it can be seen that a first shared-use path trip by the first user begins in the early afternoon. Traffic congestion is likely to be less severe at this time of day, and each time a read point is passed, the user's account is incremented by one unit. However, the user's return trip takes place after 5:00 pm when traffic congestion is likely to be more significant. During this trip, the account of the first user is incremented by 2 units each time a tag reading location is passed. In this manner, the system can be configured to provide a greater incentive for shared-path usage at peak times of day. Likewise, for resort communicates, shared-path use may be rewarded more heavily during a busy in-season month than during a less busy off-season month. The particular times, dates and weightings are easily changeable and can be set based on the times that vehicular traffic congestion is most problematic.

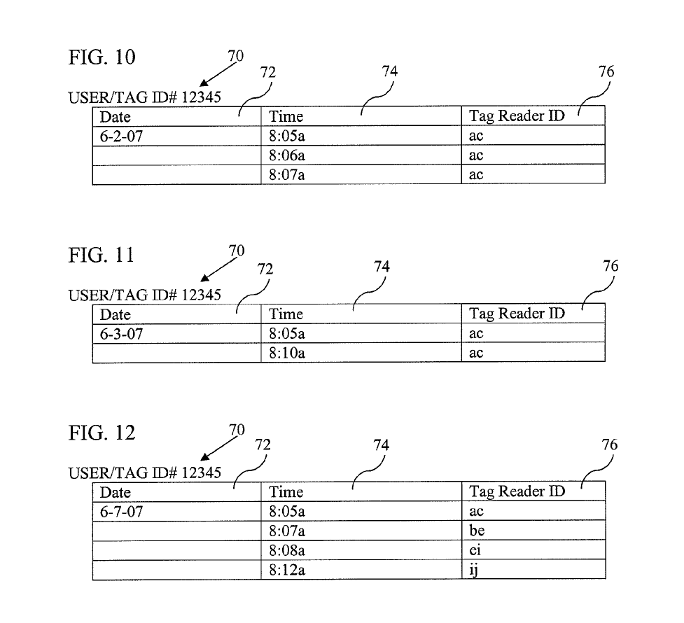

To encourage legitimate use by users who are truly substituting shared-path use for vehicular use, various checks can be made on the data in database 48 to avoid rewarding fraudulent use. For example, FIG. 10 shows that the tag of a first user is read by the tag reader at reading location ac three times during a two minute period on Jun. 2, 2007. This reading pattern does not suggest shared-path use but rather appears to be a person trying to accumulate points by standing near or riding toward and away from a single reader. It therefore may be desirable to set a minimum time between reads of the same read point, and this minimum may be determined based on the location of the read point relative to various travel destinations. FIG. 11 illustrates that first user passed read point ac two times within a five minute period. If read point ac is not near any destination, such as a store or other business, two reads within a five minute period may still be indicative of fraudulent use. However, if two reads occur at point dg within a five minute period of time, this may indicate that the user took a quick trip to non-participating business 22 and returned past reader dg on a return trip. Patterns of apparent fraud can also be tracked, such as when all system use by a given user is passed a single read point once per day. While the placement of tag readers 38 should make it difficult to obtain credits by holding a tag out the window of a passing motor vehicle, read times as illustrated in FIG. 12, which suggest movement between read points much more quickly than would be possible on a bicycle, can be noted as well, to avoid rewarding this behavior.

As has been discussed herein, one reason for implementing the system descried herein is to reduce motor-vehicle traffic. Therefore it may be desirable to avoid rewarding users of shared-use trails who are traveling a short distance and would not have used a motor-vehicle for the trip. For example, the second system user living at location 25 might take daily walks, with a dog, for example, past reading location ij. This person would therefore accumulate two credits each day for shared path use when the person would use the path even without program incentives. It therefore may be desirable to record only multi-path use where a minimum number, such as two, read points are passed on a given day or during a given trip. When a minimum number of read points must be passed in order to obtain credit for system use, it is easier to include pedestrians in the program because the potential for receiving credits for walking past a single read point is reduced.

It will generally be up to a city, town or other governmental entity to install and maintain the network of tag readers 38. This does not preclude the use of such a system by a private entity; however, for purposes of discussion, the entity maintaining the system will be referred to as a city. The city, in turn, will encourage use of the shared-use paths by providing users with suitable rewards or incentives that are made available based on the amount of shared-path use, as indicated, for example, by a running total of the number of tag readers passed over a given period of time. For example, the city could offer a reduction of a city income or property tax for persons who generate 100 units of shared-path use in a given time period. The rewards may be incremental and increase with increasing use, or a single reward may be given to each user who exceeds a certain minimum. To further encourage users to participate in the system, it is beneficial to enlist the help of businesses in the geographic location to become participating businesses. Participating businesses will install tag readers or obtain access to central database 48 or make telephones available so that customers who arrive by bicycle can record their arrival by alternative transportation mode at the participating business. The business can then craft their own set of incentives, such as discounts on products or services, to such users of the system. Of course, the businesses will see little direct benefit from having customers arrive by bicycle, and the city will therefore reimburse or offer tax based incentives to the participating businesses to encourage their participation.

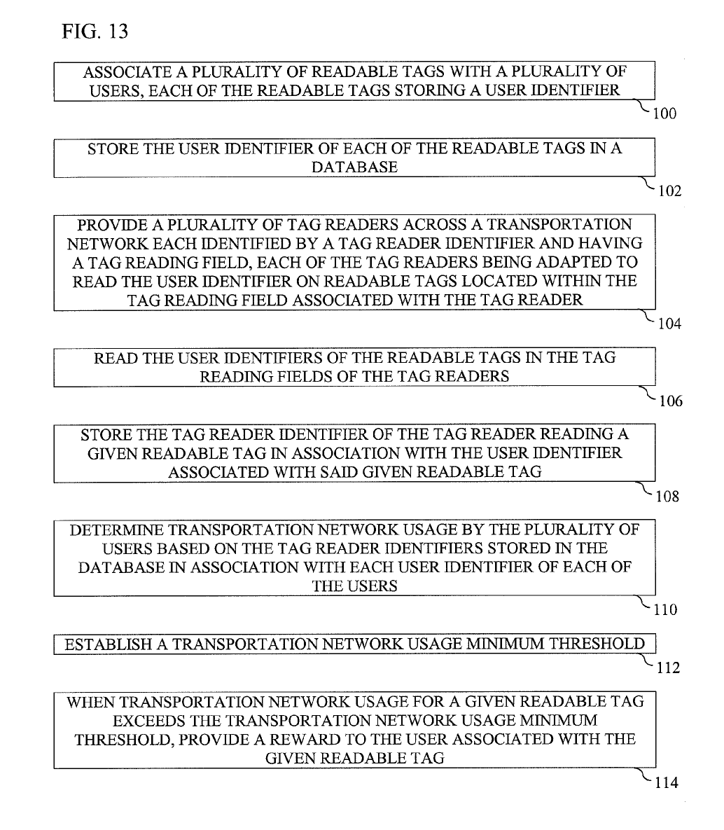

A method according to an embodiment of the present invention is illustrated in FIG. 13 and includes a first step 100 of associating a plurality of readable tags with a plurality of users, each of the readable tags storing a user identifier, a step 102 of storing the user identifier of each of the readable tags in a database, and a step 104 of providing a plurality of tag readers across a transportation network each identified by a tag reader identifier and having a tag reading field, each of the tag readers being adapted to read the user identifier on readable tags located within the tag reading field associated with the tag reader. The method further includes a step 106 of reading the user identifiers of the readable tags in the tag reading fields of the tag readers, a step 108 of storing the tag reader identifier of the tag reader reading a given readable tag in association with the user identifier associated with said given readable tag and a step 110 of determining transportation network usage by the plurality of users based on the tag reader identifiers stored in the database in association with each user identifier of each of the users. At a step 112, a transportation network usage minimum threshold is established, and at a step 114, when transportation network usage for a given readable tag exceeds the transportation network usage minimum threshold, a reward is provided to the user associated with the given readable tag.

The present invention has been described herein in terms of several preferred embodiments. However, variations of and additions to these embodiments will become apparent to those of ordinary skill in the relevant arts upon a reading of the foregoing description. It is intended that all such variations and additions form a part of the present invention to the extent they fall within the scope of the several claims appended hereto.

I claim:

1. A method comprising:
associating a plurality of readable tags with a plurality of users, each of the readable tags storing a user identifier;
storing the user identifier of each of the readable tags in a database;
providing a plurality of tag readers across a transportation network each identified by a tag reader identifier and having a tag reading field, each of the tag readers being adapted to read the user identifier on readable tags located within the tag reading field associated with each tag reader;
reading the user identifiers of the readable tags in the tag reading fields of the tag readers;
storing the tag reader identifier of the tag reader reading a given readable tag in association with the user identifier associated with said given readable tag;
determining transportation network usage by the plurality of users based on the tag reader identifiers stored in the database in association with each user identifier of each of the users;
establishing a transportation network usage minimum threshold; and
when transportation network usage for a given readable tag exceeds the transportation network usage minimum threshold, providing a reward to the user associated with the given readable tag.

2. The method of claim 1 wherein said step of associating a plurality of readable tags with a plurality of users comprises the step of mounting the readable tags on an alternative transportation device.

3. The method of claim 1 wherein said step of determining transportation network usage comprises the steps of:
associating a usage field in the database with each of the user identifiers; and
incrementing the usage field associated with the given readable tag by a value when the given readable tag is read by one of the plurality of tag readers.

4. The method of claim 1 wherein said step of storing the tag reader identifier of the tag reader reading a given readable tag comprises the step of storing a first tag reader identifier and a second tag reader identifier in association with the user identifier; and including the additional steps of:
associating a usage field in the database with each of the user identifiers; and
incrementing the usage field associated with the given readable tag when the second tag identifier is different than the first tag identifier.

5. The method of claim 3 including the additional steps of:
determining a read time at which the reading of the user identifiers on the readable tags occurs; and
storing said read time in association with the tag reader identifier of the tag reader reading the readable tag.

6. The method of claim 5 wherein said step of incrementing the usage field by a value comprises the step of incrementing the usage field by a value dependent upon said read time.

7. The method of claim 1 including the additional steps of:
associating a usage field in the database with each of the user identifiers;
reading the user identifier from the first one of the readable tags in the tag reading field of the first tag reader at a first time;
reading the user identifier from the first one of the readable tags in the tag reading field of the first tag reader at a second time;
determining an interval between the first time and the second time; and
incrementing the usage field associated with the first readable tag by a value or a weighting of a value only if the second time exceeds the first time by at least a predetermined amount.

8. The method of claim 1 including the additional step of determining whether the user of the given readable tag arrived at a given establishment via the transportation network and wherein said step of providing a reward comprises the step of providing a reward specific to the given establishment.

9. A method comprising:
associating a plurality of readable tags with a plurality of users, each of the readable tags storing a user identifier;
storing the user identifier of each of the readable tags in a database;
providing a plurality of tag readers across a transportation network, each of the tag readers being identified by a tag reader identifier and having a tag reading field, each of the tag readers being adapted to read the user identifier on readable tags located within the tag reading field associated with the tag reader;
reading the user identifier from a first one of the plurality of readable tags in the tag reading field of a first tag reader;
storing the tag reader identifier of the tag reader reading the user identifier and a reading time in the database in association with the user identifier;
determining transportation network usage by each of the users based on the tag reader identifiers and reading times stored in the database in association with each user identifier;
establishing a transportation network usage minimum threshold; and
when transportation network usage for a given readable tag exceeds the transportation network usage minimum threshold, providing a reward to the user associated with the given readable tag.

10. The method of claim 9 including the additional step of storing information related to a geographic location of each of the plurality of tag readers with respect to the transportation network.

11. The method of claim 9 wherein said step of determining network usage comprises the steps of:
providing a transportation network usage field in association with each of the user identifiers; and
determining elapsed time between a first reading time and a second reading time associated with a given user identifier;
incrementing the value of the network usage field for the user identifier of the given one of the plurality of readable tags when the elapsed time is indicative of acceptable transportation network usage.

12. The method of claim 10 wherein said step of determining network usage comprises the steps of:
providing a transportation network usage field in association with each of the user identifiers;
storing a tag reader network location in association with the plurality of tag readers;
determining an elapsed time between a first reading time and a second reading time associated with a given user identifier;
identifying the tag reader reading the given user identifier at the first reading time and identifying the tag reader reading the given user identifier at the second reading time;
incrementing the value of the network usage field for the user identifier of the given one of the plurality of readable tags when the elapsed time and the geographic location of the tag reader reading the given user identifier at the first reading time and the geographic location of the tag reader reading the given user identifier at the second reading time are indicative of acceptable transportation network usage.

13. The method of claim 12 wherein said step of incrementing the value of the transportation network usage field comprises the step of incrementing the value by an amount related to the first reading time.

14. The method of claim 12 wherein said step of incrementing the value of the network transportation usage field comprises the step of incrementing the value based on an amount related to a time of year.

15. The method of claim 9 including the additional step of determining whether the user of a given readable tag arrived at a given establishment via the transportation network and wherein said step of providing a reward comprises the step of providing a reward specific to the given establishment.

16. A method comprising:
associating a plurality of readable tags with a plurality of users, each of the readable tags storing a user identifier;
storing the user identifier of each of the readable tags in a database;
providing a plurality of tag readers across a transportation network, each of the plurality of tag readers being identified by a tag reader identifier and a tag reader network location, each of the plurality of tag readers having a tag reading field and being adapted to read the user identifier on readable tags located within the tag reading field associated with the tag reader;
providing a transportation network usage field in association with each of the user identifiers;
reading the user identifier from a first one of the plurality of readable tags in the tag reading field of a first tag reader;
storing the tag reader identifier of the tag reader reading the user identifier and a first reading time in the database in association with the user identifier;
reading the user identifier from the first one of the plurality of readable tags in the tag reading field of a second tag reader;
storing the tag reader identifier of the tag reader reading the user identifier and a second reading time in the database in association with the user identifier;
incrementing said transportation network usage field based on the first reading time or the second reading time and based on an elapsed time between said first reading time and said second reading time and based on the tag reader network location of the tag reader reading the user identifier at the first reading time and the network location of the tag reader reading the user identifier at the second reading time;
establishing a transportation network usage minimum threshold; and
when transportation network usage for a given readable tag exceeds the transportation network usage minimum threshold, providing a reward to the user associated with the given readable tag.
